(19) United States
(12) Patent Application Publication
(10) Pub. No.: US 2025/0234411 A1
(43) Pub. Date: Jul. 17, 2025

(54) METHOD AND DEVICE FOR SUPPORTING MOVEMENT OF UNMANNED AERIAL VEHICLE

(71) Applicant: Samsung Electronics Co., Ltd., Suwon-si, Gyeonggi-do (KR)

(72) Inventors: Hong WANG, Beijing (CN); Lixiang XU, Beijing (CN); Weiwei WANG, Beijing (CN)

(21) Appl. No.: 18/852,976

(22) PCT Filed: Mar. 29, 2023
(86) PCT No.: PCT/KR2023/004153

§ 371 Date: Sep. 30, 2024

(30) Foreign Application Priority Data
Mar. 31, 2022 (CN) 202210344831.5

(51) Int. Cl. H04W 76/20; H04L 5/00; H04W 36/08; H04W 64/00; H04W 68/02; H04W 84/06

(52) U.S. Cl. CPC H04W 76/20; H04L 5/0051; H04W 36/08; H04W 64/006; H04W 68/02; H04W 84/06

(57) ABSTRACT

The disclosure relates to a 5G or 6G communication system for supporting a higher data transmission rate. The present application discloses a method and device in a wireless communication system. According to one aspect of the present disclosure, there is provided a method performed by a first node in a wireless communication system, the method comprising: receiving a first message from a second node, the first message including flight route information; and allocating a resource for a user equipment UE based on the first message.

### CROSS-REFERENCE TO RELATED APPLICATION(S)

This application is a U.S. National Phase Entry of PCT International Application No. PCT/KR2023/004153, which was filed on Mar. 29, 2023, and claims priority to a Chinese Patent Application No. 202210344831.5, which was filed on Mar. 31, 2022 in the Chinese Intellectual Property Office, the entire disclosure of which is incorporated herein by reference.

### TECHNICAL FIELD

The present application relates to wireless communication technology, and in particular, to an improved method and device for supporting movement of an unmanned aerial vehicle.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

### DISCLOSURE OF INVENTION

### Technical Problem Solution to Problem

According to one aspect of the present disclosure, there is provided a method performed by a first node in a wireless communication system, the method comprising: receiving a first message from a second node, the first message including flight route information; and allocating a resource for a user equipment UE based on the first message.

In a further embodiment, the method comprises receiving, from a second node, a first message including indication information related to aerial vehicle; and allocating a resource for a user equipment (UE) based on the first message, wherein the first node is related to a target base station and the second node is related to one of a core network or a source base station.

In a further embodiment, the flight route information comprises at least one timestamp and location information corresponding to the timestamp(s).

In a further embodiment, the first message further comprises a flight altitude and/or flight speed of the UE.

In a further embodiment, the method further comprises: receiving from the second node information on an entry prohibited area, the information on the entry prohibited area indicating a range in which the UE is not allowed to enter; and performing UE mobility management based on the information on the entry prohibited area.

In various embodiments, the information on the entry prohibited area comprises at least one of: information on an identifier of the cell, information on a location of a global positioning system GPS of the UE, and information on a tracking area TA.

In various embodiments, the information on the entry prohibited area is received through the first message or a second message.

In a further embodiment, the method further comprises: receiving information on an alternative route from the second node, the information on the alternative route indicating information on an alternative route for the case when the UE is temporarily prohibited from entering an area; and performing UE mobility management based on the information on the alternative route.

In various embodiments, the information on the alternative route is received through the first message or the second message.

In various embodiments, the information on the alternative route is transmitted to the UE through an RRC message.

In a further embodiment, the method further comprises: receiving, from the second node, uplink sounding reference signal SRS configuration information of the UE, wherein the uplink SRS configuration information is saved in a UE context for uplink interference detection.

In a further embodiment, the uplink SRS configuration information is received through the first message.

In various embodiments, the first message is at least one of: a UE context setup request message, a handover request message, a UE context modification request, a route switching response, and an RETRIEVE UE Context response message.

In various embodiments, the first message is a configuration request message or a bearer context setup request message.

In various embodiments, the second message is at least one of: a UE context setup request message, a handover request message, a UE context modification request, a route switching response, and an RETRIEVE UE Context response message.

In various embodiments, the second message is a configuration request message and a bearer context setup request message.

In various embodiments, the first node may be a source base station or a destination base station or a base station centralized unit control plane CU-CP node or a base station distributed unit DU or a base station centralized unit user plane CU-UP node.

In various embodiments, the second node may be a source base station, a destination base station, a base station centralized unit control plane CU-CP node, or a core network node.

In a further embodiment, the method further comprises: determining whether to transmit a paging message to the UE based on the flight route information; wherein the first node is a base station, the second node is a core network node, and the first message is a paging message.

According to another aspect of the present disclosure, there is provided a first node in a wireless communication system, comprising: a transceiver configured to transmit and receive a signal; and a controller coupled to the transceiver and configured to perform operations in the method as described above.

In various embodiments, the first node is a source base station or a destination base station or a base station distributed unit DU or a base station centralized unit user plane CU-UP node or a base station centralized unit control plane CU-CP node.

According to another aspect of the present disclosure, there is provided a method performed by a user equipment UE in a wireless communication system, the method comprising: receiving information on an entry prohibited area from a base station, the information on the entry prohibited area indicating a range in which the UE is not allowed to enter; and performing cell selection based on the information on the entry prohibited area.

In a further embodiment, the method further comprises: transmitting a first message to the base station, wherein the first message comprises flight route information, and the first message is used by the base station to allocate a resource for the user equipment UE.

In one embodiment, the flight route information comprises at least one timestamp and location information corresponding to the timestamp(s).

In a further embodiment, the first message further comprises a flight altitude and/or flight speed of the UE.

In a further embodiment, the method further comprises: receiving the information on the alternative route transmitted through a RRC message from the base station.

According to another aspect of the present disclosure, there is provided a user equipment UE in a wireless communication system, comprising: a transceiver configured to transmit and receive a signal; and a controller coupled to the transceiver and configured to perform operations in the method as described above.

### BRIEF DESCRIPTION OF DRAWINGS

FIG. 1 is a system architecture diagram of System Architecture Evolution (SAE);

FIG. 2 is a schematic diagram of an architecture of 5G;

FIG. 3 is a flow chart of a method of Embodiment 1 of the present application;

FIG. 4 is a flow chart of a method of Embodiment 2 of the present application;

FIG. 5 is a flow chart of a method of Embodiment 3 of the present application;

FIG. 6 is a flow chart of a method of Embodiment 4 of the present application;

FIG. 7 is a flow chart of a method of Embodiment 5 of the present application;

FIG. 8 is a flow chart of a method of Embodiment 6 of the present application;

FIG. 9 is a flow chart of a method of Embodiment 7 of the present application;

FIG. 10 is a flowchart of a method of Embodiment 8 of the present application; and

FIG. 11 is a schematic diagram of a first node according to an exemplary embodiment of the present disclosure.

### MODE FOR THE INVENTION

In order to make the objectives, solutions and advantages of the embodiments of the present disclosure more clear, the solutions of the embodiments of the present disclosure will be clearly and completely described below with reference to the accompanying drawings of the embodiments of the present disclosure. Obviously, the described embodiments are some, but not all, of the embodiments of the present disclosure. Based on the described embodiments of the present disclosure, all other embodiments obtained by persons skilled in the art without creative efforts shall fall within the scope of the present disclosure.

Before undertaking the detailed description below, it may be advantageous to set forth definitions of certain words and phrases used throughout this patent document. The term “couple” and its derivatives mean any direct or indirect communication between two or more elements, whether or not those elements are in physical contact with each other. The terms “transmit”, “receive” and “communicate” and their derivatives encompass both direct and indirect communications. The terms “include” and “comprise,” as well as derivatives thereof, mean inclusion without limitation. The term “or,” is inclusive, meaning and/or. The phrase “associated with” and derivatives thereof, mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system or part thereof that controls at least one operation. Such a device may be implemented in hardware, firmware or software, or some combination of at least two of the same. The functionality associated with any particular controller may be centralized or distributed, whether locally or remotely. The phrase “at least one of” when used with a list of items means that different combinations of one or more of the listed items may be used, and that only one item of the list may be required. For example, “at least one of A, B, and C” comprises any of the following combinations: A, B, C, A and B, A and C, B and C, and A and B and C. For example, “at least one of A, B, or C” comprises any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

The terminology used herein to describe embodiments of the invention is not intended to limit and/or define the scope of the invention. For example, unless otherwise defined, technical or scientific terms used in this disclosure should be given the ordinary meaning as understood by one of ordinary skill in the art to which this invention belongs.

It should be understood that use of “first,” “second,” and similar terms in this disclosure do not denote any order, quantity, or importance, but are merely used to distinguish the various components. Unless the context clearly dictates otherwise, the singular forms “a,” “an,” or “the” and similar words do not denote a limitation of quantity, but rather denote the presence of at least one.

As used herein, any reference to “one example” or “example”, “one embodiment” or “an embodiment” means that a particular element, feature, structure or characteristic described in connection with the embodiment is included in at least one in the examples. The appearances of the phrases “in one embodiment” or “in one example” in various places in the specification are not necessarily all referring to the same embodiment.

As used herein, “a portion” of something means “at least some” of that thing, and thus may mean less than all or all of that thing. Thus, “a part” of a thing comprises the whole thing as a special case, i.e., instances where the whole thing is a part of the thing.

It will be further understood that the terms “comprise” or “include” and similar words mean that the elements or things appearing before the word encompass the elements or things listed after the word and their equivalents, but do not exclude other elements or things. Words like “connected” or “connected” are not limited to physical or mechanical connections, but may comprise electrical connections, whether direct or indirect. “Up”, “Down”, “Left”, “Right”, etc. are only used to represent the relative positional relationship, and when the absolute position of the described object changes, the relative positional relationship may also change accordingly.

The various embodiments discussed below to describe the principles of the present disclosure in this patent document are by way of illustration only and should not be construed in any way to limit the scope of the disclosure. Those skilled in the art will understand that the principles of the present disclosure may be implemented in any suitably arranged wireless communication system. For example, although the following detailed description of embodiments of the present disclosure will be directed to LTE and 5G communication systems, those skilled in the art will appreciate that the main points of the present disclosure may be modified slightly without substantially departing from the scope of the present disclosure. It can be applied to other communication systems with similar technical background and channel format. The solutions of the embodiments of the present application may be applied to various communication systems. For example, the communication systems may comprise a Global System for Mobile communications (GSM) system, a code division multiple access (CDMA) system, a broadband Code Division Multiple Access (WCDMA) system, General Packet Radio Service (GPRS), Long Term Evolution (LTE) system, LTE Frequency Division Duplex (FDD) system, LTE Time Division Duplex (TDD), universal mobile telecommunication system (UMTS), worldwide interoperability for microwave access (WiMAX) communication system, fifth generation (5th generation, 5G) system or new radio (NR), etc. In addition, the solutions of the embodiments of the present application may be applied to future-oriented communication technologies. In addition, the solutions of the embodiments of the present application may be applied to future-oriented communication technologies.

The following description with reference to the accompanying drawings is provided to facilitate a comprehensive understanding of various embodiments of the present disclosure as defined by the claims and their equivalents. This description comprises various specific details to facilitate understanding but should be regarded as exemplary only. Accordingly, those of ordinary skill in the art will recognize that various changes and modifications of the various embodiments described herein can be made without departing from the scope and spirit of the present disclosure. Also, descriptions of well-known functions and constructions may be omitted for clarity and conciseness.

The terms and phraseology used in the following specification and claims are not limited to their dictionary meanings, but, are merely used by the inventor to enable a clear and consistent understanding of the present disclosure. Accordingly, it should be apparent to those skilled in the art that the following description of various embodiments of the present disclosure is provided for illustration purposes only and not for the purpose of limiting the scope of the present disclosure as defined by the appended claims and their equivalents.

It should be understood that the singular forms “a”, “an” and “the” include plural referents unless the context clearly dictates otherwise. Thus, for example, reference to “a component surface” comprises reference to one or more of such surfaces.

The terms “comprise” or “may comprise” refer to presence of a correspondingly disclosed function, operation, or component that may be used in various embodiments of the present disclosure, rather than excluding presence of one or more additional functions, operations, or features. Furthermore, the terms “comprise” or “have” may be interpreted to mean certain characteristics, numbers, steps, operations, constituent elements, components, or combinations thereof, but should not be interpreted as excluding one or more other characteristics, numbers, steps, operations, constituent elements, components, or the possibility of existence of a combination thereof.

The term “or” as used in various embodiments of the present disclosure comprises any of the listed terms and all combinations thereof. For example, “A or B” may comprise A, may comprise B, or may comprise both A and B.

Unless defined differently, all terms (including technical or scientific terms) used in this disclosure have the same meaning as understood by one of ordinary skill in the art described in this disclosure. Common terms as defined in dictionaries are to be interpreted to have meanings consistent with the context in the relevant technical field, and should not be interpreted ideally or overly formalized unless explicitly so defined in this disclosure.

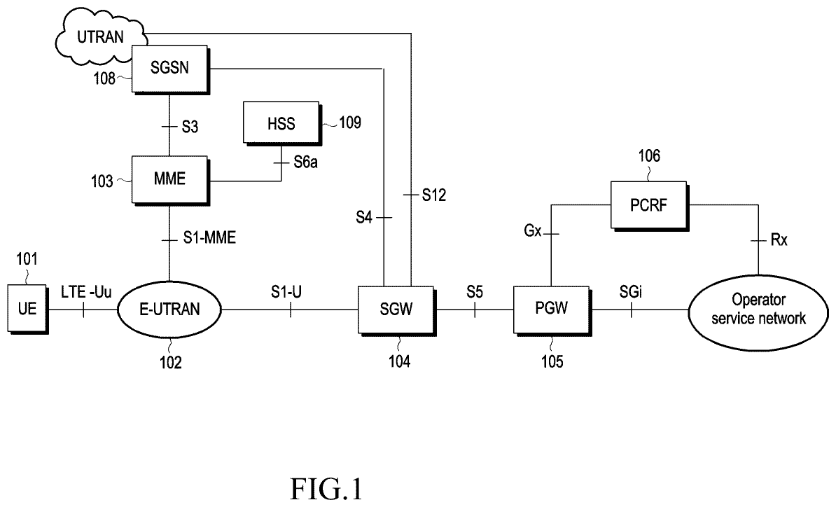

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

FIG. 1 is an exemplary system architecture 100 for System Architecture Evolution (SAE). User Equipment (UE) 101 is a terminal device for receiving data. Evolved Universal Terrestrial Radio Access Network (E-UTRAN) 102 is a radio access network that comprises macro base stations (eNodeBs/NodeBs) that provide UEs with an interface to access to a radio network. Mobility Management Entity (MME) 103 is responsible for managing mobility context, session context and security information of the UE. Serving Gateway (SGW) 104 mainly provides functions of a user plane, and the MME 103 and the SGW 104 may be in the same physical entity. Packet Data Network Gateway (PGW) 105 is responsible for functions such as charging and lawful interception, and may also be in the same physical entity as the SGW 104. Policy and Charging Rules Function (PCRF) 106 provides Quality of Service (QoS) policies and charging criteria. Serving GPRS Support Node (SGSN) 108 is a network node device in Universal Mobile Telecommunications System (UMTS) that provides routing for transmission of data. Home Subscriber Server (HSS) 109 is a home subsystem of the UE, and is responsible for preserving user information including a current location of the user equipment, an address of the serving node, user security information, and a packet data context of the user equipment.

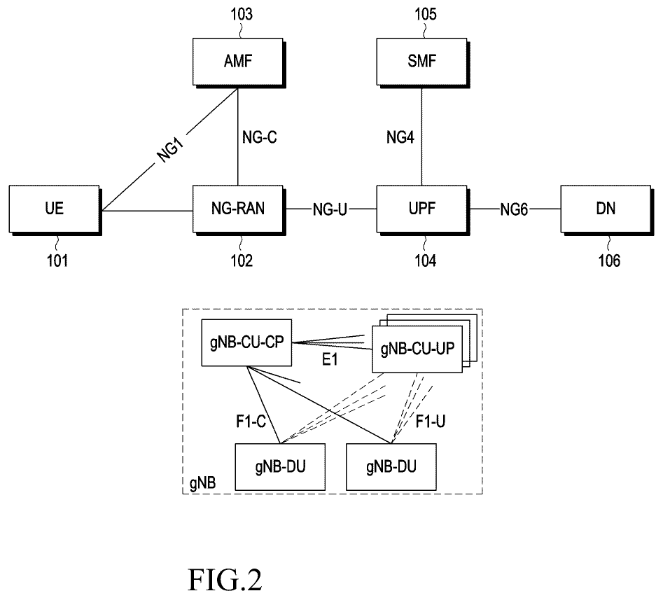

FIG. 2 is an exemplary system architecture 200 according to various embodiments of the present disclosure. Other embodiments of the system architecture 200 may be used without departing from the scope of this disclosure.

User Equipment (UE) 201 is a terminal device for receiving data. Next Generation Radio Access Network (NG-RAN) 202 is a radio access network that comprises base stations (gNBs or eNBs connected to the 5G core network 5GC, also called ng-gNBs) that provide UEs with access to the radio network interface. Access Control and Mobility Management Function (AMF) 203 is responsible for managing a mobility context and security information of the UE. User Plane Function (UPF) 204 mainly provides functions of a user plane. Session Management Function SMF 205 is responsible for session management. Data Network (DN) 206 comprises services by an operators, access to Internet, and third-party services and the like. The interface between AMF and NG-RAN is called NG-C interface, or NG interface, or N2 interface. The interface between UPF and NG-RAN is called NG-U interface, or N3 interface, and the signaling between UE and AMF is called Non-Access stratum Signaling (NAS), which is also called N1 interface. The interface between base stations is called Xn interface. A base station of NG-RAN is called gNB, and a gNB may be a split base station. A gNB comprises three entities: gNB-CU-CP, gNB-CU-UP and gNB-DU. gNB-CU-CP (gNB Centralized Unit Control Plane) is a control plane entity of the gNB centralized node, gNB-CU-UP (gNB Centralized Unit User Plane) is a user plane of the gNB centralized node, and gNB-DU (gNB Distributed Unit) is a distributed node, wherein, gNB-CU-UP and gNB-CU-UP may be set together, called gNB base station node gNB-CU. The interface between gNB-CU-CP and gNB-CU-UP is called E1 interface, and the interface between gNB-CU-CP and DU is called F1 interface, which only has control plane functions. The interface between gNB-CU-UP and DU is also an F1 interface, which only has user plane functions.

Exemplary embodiments of the present disclosure are further described below in conjunction with the accompanying drawings.

The text and figures are provided by way of example only to aid in understanding of the present disclosure. They should not be construed to limit the scope of the present disclosure in any way. While certain embodiments and examples have been provided, based on the disclosure herein, it will be apparent to those skilled in the art that the illustrated embodiments and examples may be varied without departing from the scope of the present disclosure.

The present application provides methods and devices for supporting movement of unmanned aerial vehicles. An unmanned aerial vehicle may be effectively controlled, so as to avoid the unmanned aerial vehicle from flying into a forbidden area, improve a base station handover success rate for the unmanned aerial vehicle, reduce a waste of network resources, and improve handover performance.

In recent years, the business needs of unmanned aerial vehicles have greatly increased, such as unmanned aerial vehicles for delivery, unmanned aerial vehicle for shows, and unmanned aerial vehicles to be personally controlled for experience of fun of flying. Based on these needs, it is necessary to improve the ability to remotely control unmanned aerial vehicles and facilitate the transmission of data between a system and unmanned aerial vehicles, which are also businesses that mobile operators and unmanned aerial vehicle manufacturers are concerned about.

The field of research by this application mainly focuses on a case where an altitude of an Unmanned Aerial Vehicle (UAV for short) is below 1 km. The method of this application controls the unmanned aerial vehicle through a mobile communication system, and the functions of the mobile communication need corresponding enhancement to accommodate characteristics of the UAV. For example, it is necessary to enhance the mobility management process to increase the success rate of base station handover for the unmanned aerial vehicle, reduce the waste of network resources, and improve the handover performance, in view of flight altitudes and fast movement of the unmanned aerial vehicle. In view of the situation that a flight altitude of the unmanned aerial vehicle is higher than that of ordinary user, it is necessary to effectively control the unmanned aerial vehicle to avoid the unmanned aerial vehicle from flying into a forbidden area. Furthermore, the interference to a communication system by an unmanned aerial vehicle is higher than the interference caused by ordinary users to the system, hence it is necessary to enhance uplink and downlink interference detection and cancellation of the mobile communication system.

In the following embodiments, a 5G system is taken as an example, the method is applicable to a 5G split architecture and a non-split architecture, and is also applicable to other systems, such as an LTE system. For other systems, the method may be applicable to corresponding entities of the other systems with corresponding adaptations and changes.

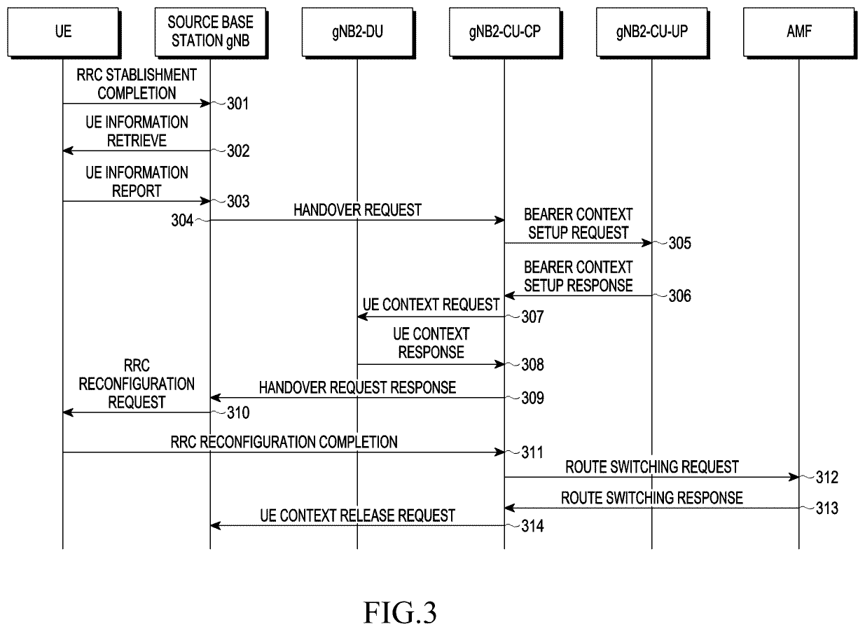

Embodiment 1 of FIG. 3 describes an example handover procedure of a UE. In this embodiment, a source base station obtains flight route information transmitted by the UE. In this case, the UE may be an unmanned aerial vehicle or an aircraft of other modes. The unmanned aerial vehicle is taken as an example below. In this embodiment, in the case where the unmanned aerial vehicle moves to a coverage of another base station, the source base station initiates a handover process of the unmanned aerial vehicle, and transmits the information of the flight route to a destination base station. The destination base station can effectively allocates resources to increase an handover success rate of the unmanned aerial vehicle, reduce the waste of network resources, and improves handover performance. The specific process is illustrated in FIG. 3.

Step 301: In the process of establishing an RRC (Radio Resource Control) connection, the UE transmits indication information as to whether it has a flight route to the source base station. Specifically, the UE includes the indication information in the RRC establishment complete message, indicating whether the UE has saved the flight route information. The flight route information is a predetermined flight route of the UE, indicating a route planned by the UE to fly, and comprises a set of location information and a corresponding timestamp.

Step 302: The source base station transmits a message to the UE, notifying the UE to transmit the flight route information to the base station. The base station may transmit an RRC message, through which the UE is notified that the source base station requests to obtain the flight route information saved by the UE, and upon receipt of the message, the UE transmits the flight route information to the source base station through the process of step 303.

Step 303: The UE transmits the flight route information to the source base station. The flight route information is carried by an RRC message, the RRC message is transmitted to the source base station, and the flight route information comprises a set of location information and timestamp information. The location information may be Global Positioning System (GPS) information, and the timestamp information may be absolute time. The flight route information identifies a planned flight route of the UE, and may be pre-configured on the UE side.

Step 304: The source base station transmits a handover request message to the destination base station.

The source base station determines to hand over the UE to the destination base station according to a UE measurement result. The handover request message comprises an identifier of the destination cell and a list of protocol data unit (Protocol Data Unit, PDU) sessions being performed by the UE, and the PDU session list comprises PDU session identifiers, Quality of Service (QoS) flow identifiers, service quality requirement of the QoS flow(s) and uplink data receiving addresses, such as IP addresses and TEIDs (Tunnel Endpoint Identifiers), which are allocated by the core network user plane node UPF.

If the destination base station is a split architecture, the destination base station comprises a base station centralized unit control plane entity or a base station centralized unit control plane node (gNB-CU-CP node or gNB-CU-CP), a base station centralized unit user plane entity or a base station centralized unit user plane node (gNB-CU-UP node or gNB-CU-UP) and a base station distributed unit gNB-DU. The message in this step is transmitted to the destination base station centralized unit control plane entity, that is, the gNB-CU-CP.

The handover request message may also carry one or more of the following information:
Indication information, which indicates whether the UE is a UE of UAV type, or whether it has functions of an unmanned aerial vehicle. The indication information is authentication information of the UE, which is transmitted from the core network to the source base station.
Flight route information. In this embodiment, the flight route information is received from the UE, and the flight route information comprises a set of location information and timestamp information.
Uplink Sounding Reference Signal (SRS) configuration information.
Flight altitude. The source base station may obtain the flight altitude of the UE through the measurement report of the UE.
Flight speed. The source base station may obtain the flight speed of the UE through the measurement report of the UE.

Upon receiving the handover request message, the destination base station may reserve or allocate resources for the UE according to the time stamp, so as to avoid premature allocation of resources and a waste of resources. The destination base station gets the knowledge of the uplink SRS configuration information of the UE, and may save this information in the context of the UE, and this information may be used by the base station to detect uplink interference.

Upon receiving the handover request message, the destination base station knows that the UE is of the UAV type, and the destination base station makes corresponding preparations for serving the UAV. If the message comprises flight route information, and/or flight altitude and speed of the UE, the destination base station may more specifically know when the UE will move to a cell in the coverage of the base station, and the destination base station makes corresponding preparations for serving the UAV. A general base station serves subscribers on the ground, and the angle of the antenna is facing the ground. When the base station knows that a UAV subscriber may move to the coverage of the base station, the base station may adjust the angle of the antenna and increase the number of antennas with an upward inclination, which enables the signals of the cell to cover the air. The destination base station receives the handover request message and obtains the flight route information. The destination base station knows the UE will fly into its cell just at a certain time through the location information and timestamp information contained in the flight route information. The gNB-CU-CP may determine when to transmit the messages in steps 305 and 307 according to the stamp information, so as to avoid premature transmissions and waste of resources.

Step 305: The gNB-CU-CP transmits a bearer context setup request message to the gNB-CU-UP.

The gNB-CU-CP transmits the bearer context setup request message to gNB-CU-UP. The message comprises identifier of the UE on the E1 interface, encryption information, and service operator identifier PLMN ID (Public Land Mobile Network ID), the message also comprises identifier of the UE in the access network (RAN UE ID, Radio Access Network UE ID), identifier of the base station distributed unit DU, and a list of PDU sessions to be established. The list of PDU sessions comprises PDU session identifiers, S-NSSAI, encryption indication, and uplink transport layer addresses, such as IP addresses and TEIDs. This information is allocated by the core network user plane node UPF (User Plane Function) for receiving uplink data. The list of PDU sessions also comprises a list of DRBs (Data Radio Bearers) to be established. The list of DRBs comprises DRB identifiers, quality of service (QoS) of the DRBs, SDAP (Service Data Adaptation Protocol) configuration, PDCP (Packet Data Convergence Protocol) configuration, PDCP sequence number states, cell group information, and a list of QoS flows to be established, the mapping of the QoS flows to data radio bearer is determined by the gNB-CU-CP. The list of QoS flows comprises identifiers of the QoS flows, Quality of Service (QoS) of the QoS Flows, and the like.

The bearer context setup request message may carry one or more of the following information:
Indication information, which indicates whether the UE is a UE of UAV type, or whether it has functions of an unmanned aerial vehicle. The indication information is authentication information of the UE, which is transmitted from the core network to the source base station.
Flight route information. The flight route of the UAV comprises a set of location information and timestamp information; and according to the timestamp information in the flight route information, the gNB-CU-UP may reserve or allocate resources for the UE according to the timestamp to avoid premature allocation of resources and a waste of resources;
Uplink SRS configuration information of the UE.
Timestamp information, which indicates a time when the UE arrives at gNB-CU-UP. The gNB-CU-UP may reserve or allocate resources for the UE according to the time stamp to avoid premature allocation of resources and a waste of resources.

Step 306: The gNB-CU-UP transmits a bearer context setup response message to the gNB-CU-CP.

The gNB-CU-UP transmits the bearer context setup response message to the gNB-CU-CP. The message comprises an identifier of the UE on the E1 interface, and a list of PDU sessions successfully established. The list of the PDU sessions comprises identifiers of the PDU sessions, encryption results, and downlink transport layer addresses. The addresses are allocated by the gNB-CU-UP and used to receive downlink data transmitted by the core network. The message also comprises a list of DRBs successfully established. The list of the DRBs comprises DRB identifiers, information forwarded by DRB data, and uplink user plane information of the DRBs. The uplink user plane information comprises user plane transport layer addresses, cell group identifiers, and the like. The uplink user plane addresses are allocated by the gNB-CU-CP and are used to receive uplink data transmitted by the DU.

Step 307: The gNB-CU-CP transmits a UE context setup request message to the gNB-DU.

The gNB-CU-CP transmits the UE context setup request message to the gNB-DU. The message carries identifier of the UE on the F1 interface and the configuration information of the data radio bearers DRBs to be established. The configuration information of the DRBs comprises identifiers of the DRBs, quality requirements (e.g., QoS) of the DRBs, information of QoS flows mapped to the DRBs, and uplink transport layer addresses of the DRBs, such as IP addresses and TEIDs, which are used to receive uplink data. This information is allocated by the gNB-CU-UP. This message also carries information such as the Radio Link Control (RLC) modes of the DRBs, the Packet Data Convergence Protocol (PDCP for short) sequence number length and the like.

The UE context setup request message may also comprise one or more of the following information:
Indication information, which indicates whether the UE is a UE of UAV type, or whether it has functions of an unmanned aerial vehicle. The indication information is authentication information of the UE, which is transmitted from the core network to the source base station.
Flight route information, which comprises a set of location information and timestamp information. The DU may also adjust the configuration of the antenna according to the location information, such as adjusting inclination of the antenna, so that the signals can cover the air. The DU reserves or allocates resources for the UE according to the comprised timestamp, so as to avoid premature allocation of resources and a waste of resources.
Timestamp information, which indicates a time when the UE arrives at DU, and the DU may reserve or allocate resources for the UE according to this time stamp, so as to avoid premature allocation of resources and a waste of resources.
Flight altitude of the UE. DU may also adjust configuration of the antenna to the altitude information, such as adjusting inclination of the antenna, so that signal can cover the air;
Flight speed of the UE. The DU reserves or allocates resources for the UE according to the comprised speed, avoiding premature allocation of resources and a waste of resources:

Step 308: The gNB-DU transmits a UE context setup response message to the gNB-CU-CP.

The gNB-DU transmits the UE context setup response message to the gNB-CU-CP. The message carries identifier of the UE on the F1, the RRC information from the DU to the CU, the Cell-Radio Network Temporary Identifier (C-RNTI for short) of the UE, and a list of DRBs successfully established. The list of the DRBs comprises identifiers of the DRBs, logical channel identifiers (Logical Channel IDs, LCIDs), and downlink transport layer addresses of the F1 interface. The RRC information from DU to CU comprises cell group configuration information CellGroupConfig, measurement gap configuration information MeasGapConfig, discontinuous line reception configuration and the like.

Step 309: The destination base station transmits a handover response message to the source base station.

The destination base station transmits the handover response message to the source base station. The message carries identifier of the UE on the Xn interface, the bearer information or PDU session information accepted at the destination base station, and the handover command message to be transmitted to the UE.

Step 310: The source base station transmits a handover command to the UE.

The source base station transmits the handover command transmitted by the destination base station to the UE.

Step 311: The UE synchronizes with the destination cell, and transmits an RRC reconfiguration complete message carrying the handover complete message to the destination base station.

Step 312: The destination base station transmits a route switching request message to the core network AMF.

The route switching request message comprises location information of the UE and a list of PDU sessions handed over to the destination base station. The location information of the UE comprises the unique identifier of the cell where the UE is located, and an identifier of the tracking area where the UE is located. The specific information of the PDU sessions handed over to the destination base station is comprised in the N2 Session Management (N2 SM) container, which comprises an address of the user plane and information of the QoS flow.

Step 313: The core network transmits a route switching response message to the destination base station.

The route switching response message comprises identifier of the UE on the NG interface, information of the bearers successful in handover or identifiers of the PDU Sessions, and N2 SM container, which comprises content of the SMF configuration, is transparent to the AMF, and comprises information of the user plane allocated by UPF and the information of QoS.

In step 314, the destination base station transmits a UE context release message to the source base station, and the source base station releases the UE context.

If there is no direct interface between the source base station and the destination base station, and the handover process needs to be forwarded through the core network, the method described in FIG. 3 is also applicable to the handover process forwarded through the core network. At this point, the source base station transmits a handover required message to the core network, and the message carries the source-to-destination transparent container. The transparent container may comprise the information in step 304, that is, the source-to-destination transparent container comprises one or more of the following information:
Indication information, which indicates whether the UE is a UE of UAV type, or whether it has functions of an unmanned aerial vehicle. The indication information is authentication information of the UE, which is transmitted from the core network to the source base station.
Flight route information of UAV. In this embodiment, the flight route information is received from the UE, and the flight route comprises a set of location information and timestamp information.
Timestamp information, which indicates a time when the UE arrives at DU, and the DU may reserve or allocate resources for the UE according to this time stamp, so as to avoid premature allocation of resources and a waste of resources.
Configuration information of uplink Sounding Reference Signal (SRS) of the UE.
Flight altitude of the UE. The source base station may obtain the flight altitude of the UE through the measurement report of the UE.
The flight speed of the UE. The source base station may obtain the flight speed of the UE through the measurement report of the UE.

The core network then transmits a handover request message to the destination base station, and the transparent container is transmitted to the destination base station through the handover request message transmitted by the core network. The behavior of the destination base station is as described in step 304. If the destination base station is a split base station, steps 305 to 308 are performed, which are not repeatedly described here.

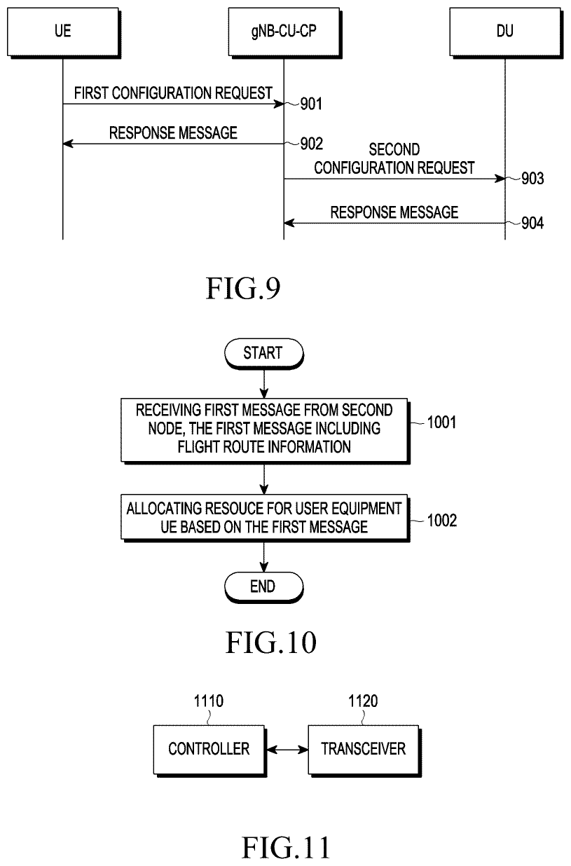

FIG. 9 depicts that in the handover process, the information that the UE is of the UAV type is notified to the destination base station. If the speed of the UE is very fast, and the destination base station needs to adjust some configuration information to be able to serve the UE of UAV type, these adjustments will take a certain time. At this point, the source base station notifies the information that the UE is of the UAV type to the destination base station as soon as possible, so that the destination base can adjust the configuration earlier. That is, the notification information about the UAV type and the handover process may be separated. This embodiment describes that the information of the UAV type is notified to the destination base station through a single process. As illustrated in FIG. 9:

Step 901: The source base station transmits a first configuration request message to the destination base station.

The source base station receives the flight route transmitted by the UE, and knows that the UE will move to the destination base station, and the UE is of a UAV type. The source base station transmits a configuration request message to the destination base station, and configuration is performed through the destination base station to support the UE of the UAV type. For example, by increase the number of the corresponding antenna, or adjusting the inclinations of the antennas, the information of the cell may cover the area into which the UE is to fly.

If the destination base station is a split architecture, the destination base station comprises a base station centralized unit control plane gNB-CU-CP node, a base station centralized unit user plane gNB-CU-UP node, and a base station distributed unit gNB-DU. The message in this step is transmitted to the destination base station centralized unit control plane entity, that is, the gNB-CU-CP.

The first configuration request message may carry one or more of the following information:
Identifier of the UE, which may be a Globally Unique AMF Identifier (GUAMI), or a base station identifier plus a C-RNTI.
Identifier of the cell, which indicates the unique identifier of the cell to which the UE may move.
Indication information, which indicates whether the UE is a UE of UAV type, or whether it has functions of an unmanned aerial vehicle. The indication information is authentication information of the UE, which is transmitted from the core network to the source base station.
Flight route information of the UAV, which comprises a set of location information and timestamp information.
Configuration information of the uplink sounding reference signal SRS of the UE.
Flight altitude of the UE.
Flight speed of the UE.

Upon receipt of the message by the destination base station, the destination base station knows the configuration information of the uplink SRS of the UE, and may save the information in the context of the UE. This information may be used by the base station to detect uplink interference.

The destination base station receives the message and knows the UE is of the UAV type, and the destination base station makes corresponding preparations for serving the UAV. If the message comprises the flight route information, and/or the flight altitude and speed of the UE, the destination base station may more specifically know when the UE will move to a cell in the coverage of the base station, and the destination base station makes corresponding preparations for serving the UAV. A general base station serves subscribers on the ground, and the angle of the antenna is facing the ground. When the base station knows that a UAV subscriber may move to the coverage of the base station, the base station may adjust the angle of the antenna and increase the number of antennas with an upward inclination, which enables the signals of the cell to cover the air.

Step 902: The destination base station transmits a response message to the source base station.

If the destination base station is a split architecture, step 903 and step 904 are also included. At this point, the message in step 901 is transmitted to the destination gNB-CU-CP. If it is a split architecture, step 902 may also be performed after receiving the message in step 904.

Step 903: The gNB-CU-CP transmits a second configuration request to the gNB-DU.

The adjustment of the antenna requires the participation of the gNB-DU, and the gNB-CU-CP transmits the received information to the gNB-DU.

The second configuration request message may carry one or more of the following information:
Identifier of the UE, which may be GUAMI, or the identifier of the base station plus the C-RNTI.
Identifier of the cell, which indicates the unique identifier of the cell to which the UE may move.
Indication information, which indicates whether the UE is a UE of UAV type, or whether it has functions of an unmanned aerial vehicle. The indication information is authentication information of the UE, which is transmitted from the core network to the source base station.
Flight route information of the UAV. The flight route of the UAV comprises a set of location information and timestamp information.
Configuration information of the uplink sounding reference signal SRS of the UE.
Flight altitude of the UE.
Flight speed of the UE.

Upon receipt of this message, the gNB-DU knows the configuration information of uplink SRS of the UE, and may save this information in the context of the UE. This information may be used by the base station to detect the uplink interference.

The gNB-DU receives this message and knows that the UE is of the UAV type, and the gNB-DU makes corresponding preparations for serving UAV. If the message comprises the flight route information, and/or the flight altitude and speed of the UE, the gNB-DU may more specifically know when the UE will move to a cell in the coverage of the base station, and the gNB-DU makes corresponding preparations for serving the UAV. A general base station serves subscribers on the ground, and the angle of the antenna is facing the ground. When the gNB-DU knows that a UAV subscriber may move to the coverage of the base station, the gNB-DU may adjust the angle of the antenna and increase the number of antennas with an upward inclination, which enables the signals of the cell to cover the air.

Step 904: The gNB-DU transmits a response message to the gNB-CU-CP.

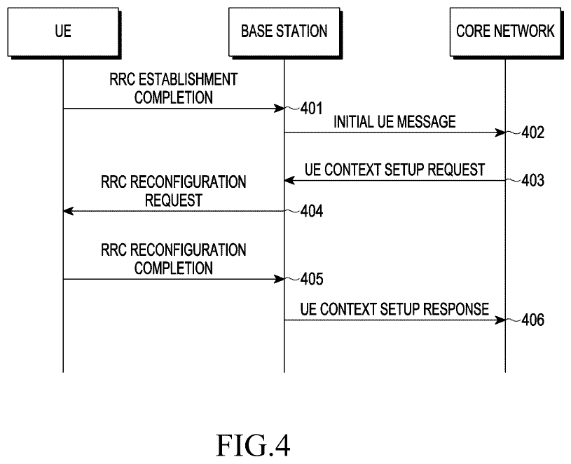

In another implementation, the core network transmits the flight route information of the UAV to the base station and the UE. FIG. 4 is a schematic diagram of a process for configuring a base station and flight route information of a UE by a core network provided according to an embodiment of the present application. This embodiment takes a 5G base station as an example. If this embodiment is to be applied to other systems, the corresponding interface and message names are also changed accordingly, and those skilled in the art will be clear about how to make these changes. As illustrated in FIG. 4:

Step 401: The UE establishes an RRC connection with the base station, and the last message about establishing the RRC connection is an RRC establishment complete message. The RRC setup complete message comprises a non-access stratum NAS message transmitted by the UE to the core network.

Step 402: The base station transmits an initial UE message to the core network mobility management entity AMF, and the message carries the above NAS message.

Step 403: The core network AMF transmits a UE context setup request message to the base station.

The core network AMF may interact with other core networks to obtain the authentication information of the UE. The UE context setup request message may comprise information of the identifier of the UE on the NG interface, the identifier GUAMI of the UE, the PDU session establishment request list, and information of the encryption capability of the UE, encryption keys, and a list of movement restrictions. The UE context setup request message also comprises one or more of the following information:
Indication information, which indicates whether the UE is a UE of UAV type, or whether it has functions of an unmanned aerial vehicle. The indication information is authentication information of the UE, which is transmitted from the core network to the source base station.
Flight route information. The flight route information comprises a set of location information and timestamp information. The flight route information is a predetermined flight route of the UE. Upon receipt of this information, the base station may refer to the flight route information of the UE when selecting the destination base station, and hand over the UE to an appropriate base station, thereby improving an success rate of the handover.
Information of an entry prohibited area for the UE. The information of the entry prohibited area indicates a range in which the UE is not allowed to enter. This information is generated by the core network, and is transmitted to the base station through the message in this step. The information of the entry prohibited area may be a set of cell identifiers, or information of a set of GPS locations, or information of a set of tracking areas TAs, such as TA identifiers, or other forms. Upon receipt of this information, the base station refers to this information when selecting a serving cell, and does not configure any cell in the entry prohibited area as a serving cell for the UE, or refers to the information of the entry prohibited area when performing handover, and does not hand over the UE to the entry prohibited area.
The information on the alternative route. When the predetermined flight route passes through an entry prohibited area, the core network configures an alternative route. When the UE flies to a location adjacent to the entry prohibited area, the flight route needs to be changed. At this point, the information on the alternative route may be used for flying to bypass the entry prohibited area. The information on the alternative route may be configured when the UE is about to fly to the entry prohibited area, or configured in advance.

Step 404: The base station transmits an RRC reconfiguration request message to the UE.

In one embodiment, the RRC reconfiguration request message comprises flight route information and/or entry prohibited area information and/or the information on the alternative route of the UE.

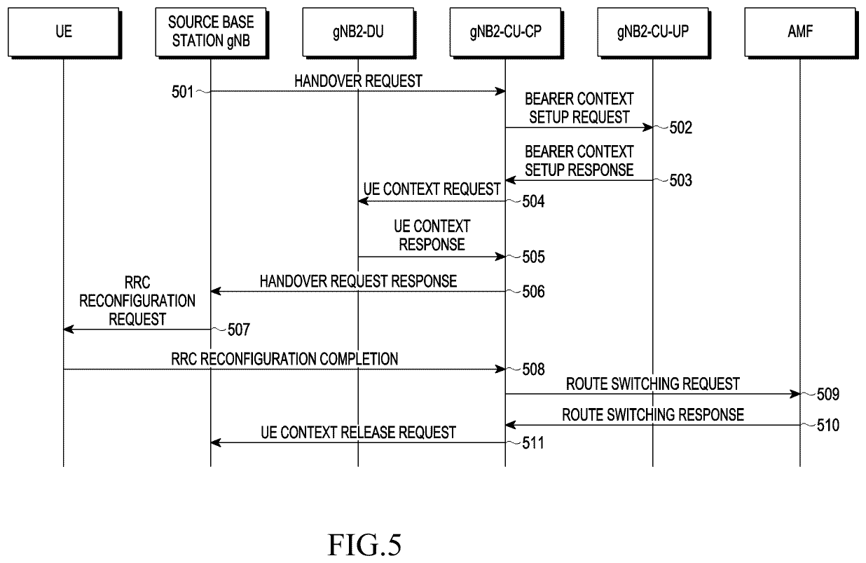

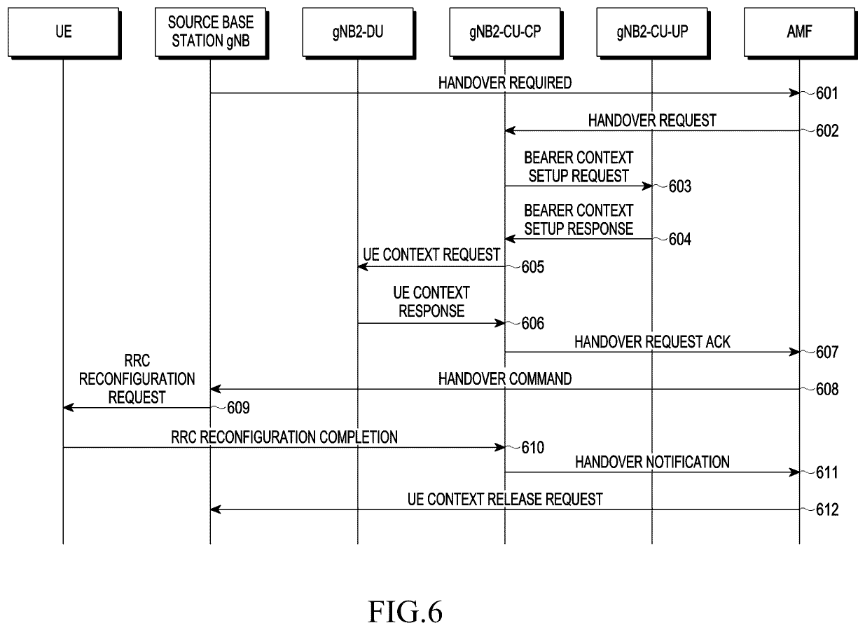

Upon receipt of this message, the UE saves the flight route information, the entry prohibited area information or the information on the alternative route of the UE in the context of the UE. When performing cell reselection, the UE refers to the entry prohibited area information to avoid accessing to a cell to which it is not allowed to enter. When approaching a cell to which a UE is not allowed to enter, an alternative route may be followed. The flight route information or the information on the alternative route saved by the UE may be reported to a new base station when the UE is handed over to the new base station. How to perform the report is described in FIG. 3, FIG. 5, and FIG. 6, which is omitted here.

Step 405: The UE transmits an RRC reconfiguration complete message to the base station.

Step 406: The base station transmits a UE context setup response message to the core network.

If the core network is to update the flight route information of the UE, or to update the entry prohibited area information of the UE, the AMF may transmit a UE context update request message, which carries information of an updated flight route, or information of an updated entry prohibited area of the UE, or information of an updated alternative route. Up receipt of this information, the base station may save this information in the context of the UE, and transmit an RRC reconfiguration request message to transmit the updated information to the UE.

FIG. 5 depicts a schematic diagram of a process in which a base station obtains flight route information or entry prohibited area information during a moving process. In this case, the UE is an unmanned aerial vehicle. In this embodiment, when the unmanned aerial vehicle moves to the coverage of another base station, the source base station initiates the handover process of the unmanned aerial vehicle, and the source base station transmits the flight route information, entry prohibited area information or the information on the alternative route to the destination base station, or the core network transmits the flight route information, entry prohibited area information or the information on the alternative route to the destination base station, thereby increasing the handover accuracy and success rate of the unmanned aerial vehicle, reducing a waste of network resources and improving the handover performance. The specific process is illustrated in FIG. 5.

Step 501: The source base station transmits a handover request message to the destination base station.

The source base station determines to hand over the UE to the destination base station according to the UE measurement result. The handover request message comprises one or more of the following: an identifier of the destination cell, and a list of PDU sessions being performed by the UE, and the PDU session list comprises PDU session identifiers, Quality of Service (QoS) flow identifiers, service quality requirements of the QoS flow(s) and uplink data receiving addresses, such as IP addresses and TEIDs, which are allocated by the core network user plane node UPF.

If the destination base station is a split structure, the destination base station comprises a base station centralized unit control plane gNB-CU-CP entity, a base station centralized unit user plane gNB-CU-UP entity, and a base station distributed unit gNB-DU. The message in this step is transmitted to the destination base station centralized unit control entity, that is, the gNB-CU-CP.

The handover request message may carry indication information of the UE identity, which indicates whether the UE is a UE of UAV type, or whether it has functions of an unmanned aerial vehicle, and may also carry flight route information of the UAV. The indication information of the UE identity is authentication information of the UE, which is transmitted from the core network to the source base station. The flight route information of UAV comprises a set of location information and timestamp information. This flight route information may be a predetermined flight route of the UE, and if the source base station obtains the flight route information of the UE from the UE or the core network, it may be included in the message. Upon receipt of this information, the destination base station may reserve or allocate resources for the UE according to the flight route information, so as to avoid premature allocation of resources and a waste of resources.

The handover request message may also carry information of areas that the UE is prohibited from entering. If the source base station obtains this information from the core network, the source base station comprises this information in the handover request message and transmits it to the destination base station. The destination base station receives this information, which is used for mobility management. When selecting a serving cell, the destination base station refers to this information, and does not configure any cell in the entry prohibited area as a serving cell of the UE, or when performing the handover, the destination base station refers to the information of the entry prohibited area, and does not hand over the UE to the entry prohibited area.

The handover request message may also comprise configuration information of uplink SRS of the UE. The destination base station knows the configuration information of uplink SRS of the UE, and may save this information in the context of the UE, and this information may be used by the base station to detect uplink interference.

The handover request message may also comprise the information on the alternative route. When the predetermined flight route passes through an entry prohibited area, the core network configures an alternative route. When the UE flies to a location adjacent to the entry prohibited area, the flight route needs to be changed. At this point, the information on the alternative route may be used for flying to bypass the entry prohibited area. The information on the alternative route may be configured when the UE is about to fly to the entry prohibited area, or configured in advance.

Step 502: The gNB-CU-CP transmits a bearer context setup request message to the gNB-CU-UP.

The gNB-CU-CP transmits the bearer context setup request message to gNB-CU-UP. The message comprises identifier of the UE on the E1 interface, encryption information, and service operator identifier PLMN ID, the identifier of the UE in the access network (RAN UE ID), the identifier of the base station distributed unit DU, and the list of PDU sessions to be established. The list of PDU sessions comprises PDU session identifiers, S-NSSAI, encryption indication, and uplink transport layer addresses, such as IP addresses and TEIDs. This information is allocated by the core network user plane node UPF for receiving uplink data. The list of PDU sessions also comprises the list of DRBs to be established. The list of DRBs comprises DRB identifiers, quality of service (QoS) of the DRBs, SDAP configuration, PDCP configuration, PDCP sequence number states, cell group information, and a list of QoS flows to be established, the mapping of the QoS flows to data radio bearers is determined by the gNB-CU-CP. The list of QoS flows comprises identifiers of the QoS flows, Quality of Service (QoS) of the QoS Flows, and the like.

The bearer context setup request message may carry indication information on identity of the UE, which indicates whether the UE is a UE of the UAV type, or whether it has functions of an unmanned aerial vehicle, and may also carry the flight route information of the UAV. The indication information of the UE identity is authentication information of the UE, which is transmitted from the core network to the source base station. The flight route information of the UAV comprises a set of location information and timestamp information, and the message may also comprise configuration information of uplink SRS of the UE. Alternatively, the bearer context setup request message may carry the indication information on the identity of the UE, and may also carry timestamp information, the timestamp information indicates a time when the UE arrives at the gNB-CU-UP, and the gNB-CU-UP may reserve or allocate resources for the UE according to the time stamp to avoid premature allocation of resources and a waste of resources.

Step 503: The gNB-CU-UP transmits a bearer context setup response message to the gNB-CU-CP.

The gNB-CU-UP transmits the bearer context setup response message to the gNB-CU-CP. The message comprises identifier of the UE on the E1 interface, and a list of PDU sessions successfully established. The list of the PDU sessions comprises identifiers of the PDU sessions, encryption results, and downlink transport layer addresses. The addresses are allocated by the gNB-CU-UP and used to receive downlink data transmitted by the core network. The message also comprises a list of DRBs successfully established. The list of the DRBs comprises DRB identifiers, information forwarded by DRB data, and uplink user plane information of the DRBs. The uplink user plane information comprises user plane transport layer addresses, cell group identifiers, and the like. The uplink user plane addresses are allocated by the gNB-CU-CP and are used to receive uplink data transmitted by the DU.

Step 504: The gNB-CU-CP transmits a UE context setup request message to the gNB-DU.

The gNB-CU-CP transmits the UE context setup request message to the gNB-DU. The message carries identifier of the UE on the F1 interface and the configuration information of the data radio bearers DRBs to be established. The configuration information of the DRBs comprises identifiers of the DRBs, Quality of Service (QoS) of the DRBs, information of the QoS flows mapped to the DRBs, and uplink transport layer addresses of the DRBs, such as IP addresses and TEIDs, which are used to receive uplink data. This information is allocated by the gNB-CU-UP. This message also carries information such as the RLC modes of the DRBs, the PDCP sequence number length and the like.

The UE context setup request message may also comprise indication information on identity of the UE, the indication information indicates whether the UE is a UE of the UAV type, or whether it has functions of an unmanned aerial vehicle, and comprises the flight route information of the UE. The flight route information comprises a set of location information and timestamp information. Alternatively, the information comprises information of time stamps, which indicate times when the UE arrives at the DU, and the DU may reserve or allocate resources for the UE according to the timestamps, so as to avoid premature allocation of resources and a waste of resources.

Step 505: The gNB-DU transmits a UE context setup response message to the gNB-CU-CP.

The gNB-DU transmits the UE context setup response message to the gNB-CU-CP. The message carries identifier of the UE on the F1, RRC information from the DU to the CU, C-RNTI of the UE, and a list of DRBs successfully established. The list of the DRBs comprises identifiers of the DRBs, logical channel identifiers (LCIDs), and downlink transport layer addresses of the F1 interface. The RRC information from DU to CU comprises cell group configuration information CellGroupConfig, measurement gap configuration information MeasGapConfig, discontinuous line reception configuration and the like.

Step 506: The destination base station transmits a handover response message to the source base station.

The destination base station transmits the handover response message to the source base station. The message carries identifier of the UE on the Xn interface, the bearer information or PDU session information accepted at the destination base station, and the handover command message to be transmitted to the UE.

Step 507: The source base station transmits a handover command to the UE.

The source base station transmits the handover command transmitted by the destination base station to the UE.

Step 508: The UE synchronizes with the destination cell and transmits a handover complete message to the destination base station.

Step 509: The destination base station transmits a route switching request message to the core network AMF.

The route switching request message comprises the location information of the UE and a list of the PDU sessions handed over to the destination base station. The location information of the UE comprises the unique identifier of the cell where the UE is located, and identifier of the tracking area where the UE is located. The specific information of the PDU sessions handed over to the destination base station is comprised in the N2 N2 SM container, which comprises address of the user plane and information of QoS flow.

Step 510: The core network transmits a route switching response message to the destination base station.

The route switching response message comprises identifier of the UE on the NG interface, information of the bearers successful in handover or identifiers of the PDU Sessions, and N2 SM container, which comprises the content of the SMF configuration, is transparent to the AMF, and comprises information of the user plane allocated by UPF and the information of QoS.

The route switching response message may carry indication information on identity of the UE, which indicates whether the UE is a UAV type UE, or whether it has functions of an unmanned aerial vehicle, and may also carry UAV flight route information. The indication information on the identity of the UE is authentication information of the UE, which is transmitted from the core network to the source base station. The flight route information of UAV comprises a set of location information and timestamp information. This flight route information is a predetermined flight route of the UE. Upon receipt of this information, the destination base station saves this information in the context of the UE, and this information is used for mobility management.

The route switching response message may also carry information of areas that the UE is prohibited from entering. If the source base station obtains this information from the core network, the source base station comprises this information in the handover request message and transmits it to the destination base station. The destination base station receives this information and saves this information in the context of the UE, which is used for mobility management. The destination base station refers to this information when selecting a serving cell, and does not configure any cell in the entry prohibited area as a serving cell of the UE, or the destination base station refers to the information of the entry prohibited area when performing the handover, and does not hand over the UE to the entry prohibited area.

The route switching response message may also comprise the information on the alternative route. When the predetermined flight route passes through an entry prohibited area, the core network configures an alternative route. When the UE flies to a location adjacent to the entry prohibited area, the flight route needs to be changed. At this point, the information on the alternative route may be used for flying to bypass the entry prohibited area. The information on the alternative route may be configured when the UE is about to fly to the entry prohibited area, or configured in advance.

In step 511, the destination base station transmits a UE context release message to the source base station, and the source base station releases the UE context.

FIG. 6 depicts another schematic diagram of a process in which a base station obtains flight route information or entry prohibited area information during a moving process. In this case, the UE is an unmanned aerial vehicle. In this embodiment, when the unmanned aerial vehicle moves to the coverage of another base station, the source base station initiates the handover process of the unmanned aerial vehicle, and the source base station transmits the flight route information or entry prohibited area information to the destination base station, or the core network transmits the flight route information or entry prohibited area information to the destination base station, thereby increasing handover accuracy and success rate of the unmanned aerial vehicle, reducing a waste of network resources and improving handover performance. The specific process is illustrated in FIG. 6.

Step 601: The source base station transmits a handover required message to the core network mobility management entity AMF.

The source base station determines to hand over the UE to the destination base station according to the UE measurement result. The handover required message carries the destination identifiers, which comprise the identifier of destination base station and identifier of the tracking area, and the message also carries identifiers of the PDU sessions being performed by the UE. The message may also carry indication information available for direct data forwarding.

The handover required message also carries a transparent container from the source base station to the destination base station. The transparent container from the source base station to the destination base station may comprise indication information on identity of the UE, which indicates whether the UE is a UE of UAV type, or whether it has functions of an unmanned aerial vehicle, and may also comprise flight route information of the UAV. The indication information on the identity of the UE is authentication information of the UE, which is transmitted from the core network to the source base station. The flight route information of the UAV comprises a set of location information and timestamp information, and the flight route information is a predetermined flight route of the UE. If the source base station obtains the information of the flight route of the UE from the UE or the core network, the information may be included in the container. Upon receipt of this information, the destination base station may reserve or allocate resources for the UE according to the time stamp, so as to avoid premature allocation of resources and a waste of resources.

The transparent container from the source base station to the destination base station may also comprise information on the area where the UE is prohibited from entering. If the source base station obtains this information from the core network, the source base station transmits the information to the destination base station by including it in the transparent container from the source base station to the destination base station. The destination base station receives this information and saves this information in the context of the UE, which is used for mobility management. The destination base station refers to this information when selecting a serving cell, and does not configure any cell in the entry prohibited area as a serving cell of the UE, the destination base station refers to the information of the entry prohibited area when performing the handover, and does not hand over the UE to the entry prohibited area.

The transparent container from the source base station to the destination base station may further comprise configuration information of uplink SRS of the UE. The destination base station knows the configuration information of uplink SRS of the UE, and may save this information in the context of the UE, and this information may be used by the base station to detect uplink interference.

The transparent container from the source base station to the destination base station may also comprise the information on the alternative route. When the predetermined flight route passes through an entry prohibited area, the core network configures an alternative route. When the UE flies to a location adjacent to the entry prohibited area, the flight route needs to be changed. At this point, the information on the alternative route may be used for flying to bypass the entry prohibited area. The information on the alternative route may be configured when the UE is about to fly to the entry prohibited area, or configured in advance.

Step 602: The AMF transmits a handover request message to the destination base station.

The handover request message carries identifier of the UE on the NG interface, encryption capability of the UE, PDU session identifiers of the UE, S-NSSAI (Single Network Slice Selection Assistance information), and specific information of PDU sessions. The specific information of the PDU sessions comprises the maximum aggregation rate of the PDU sessions, QoS flow identifiers, service quality requirements of the QoS flow(s), and uplink data receiving addresses, such as IP addresses and TEIDs, which are allocated by the core network user plane node UPF.

The handover request message may carry indication information on identity of the UE, which indicates whether the UE is a UE of the UAV type, or whether it has functions of an unmanned aerial vehicle, and may also carry the flight route information of the UAV. The indication information on the identity of the UE is authentication information of the UE, which is transmitted from the core network to the source base station. The flight route information of the UAV comprises a set of location information and timestamp information, and the flight route information is a predetermined flight route of the UE. If the source base station obtains information of the flight route of the UE from the UE or the core network, it may be included in this message. Upon receipt of this information, the destination base station may reserve or allocate resources for the UE according to the time stamp, so as to avoid premature allocation of resources and a waste of resources.

The handover request message may also carry information of areas that the UE is prohibited from entering. If the source base station obtains this information from the core network, the source base station transmits this information to the destination base station by including it in the handover request message. The destination base station receives this information. When selecting a serving cell, the destination base station refers to this information, and does not configure any cell in the entry prohibited area as a serving cell of the UE, or when performing the handover, the destination base station refers to the information of the entry prohibited area, and does not hand over the UE to the entry prohibited area.

The handover request message may also comprise the information on the alternative route. When the predetermined flight route passes through an entry prohibited area, the core network configures an alternative route. When the UE flies to a location adjacent to the entry prohibited area, the flight route needs to be changed. At this point, the information on the alternative route may be used for flying to bypass the entry prohibited area. The information on the alternative route may be configured when the UE is about to fly to the entry prohibited area, or configured in advance.

If the destination base station is a split architecture, the above handover request message is transmitted to the gNB-CU-CP.

Step 603: The gNB-CU-CP transmits a bearer establishment request message to the gNB-CU-UP.

The gNB-CU-CP transmits the bearer context setup request message to gNB-CU-UP. The message comprises identifier of the UE on the E1 interface, encryption information, and service operator identifier PLMN ID, identifier of the UE in the access network (RAN UE ID), identifier of the base station distributed unit DU, and the list of PDU sessions to be established. The list of PDU sessions comprises PDU session identifiers, S-NSSAI, encryption indication, and uplink transport layer addresses, such as IP addresses and TEIDs. This information is allocated by the core network user plane node UPF for receiving uplink data. The list of PDU sessions also comprises the list of DRBs to be established. The list of DRBs comprises DRB identifiers, quality of service (QoS) of the DRBs, SDAP configuration, PDCP configuration, PDCP sequence number states, cell group information, and a list of QoS flows to be established, the mapping of the QoS flows to data radio bearers is determined by the gNB-CU-CP. The list of QoS flows comprises identifiers of the QoS flows, Quality of Service (QoS) of the QoS Flows, and the like.

The bearer context setup request message may carry indication information on identity of the UE, which indicates whether the UE is a UE of the UAV type, or whether it has functions of an unmanned aerial vehicle, and may also carry the flight route information of the UAV. The indication information on the identity of the UE is authentication information of the UE, which is transmitted from the core network to the source base station. The flight route information of the UAV comprises a set of location information and timestamp information, and the flight route information is a predetermined flight route of the UE. The message may also comprise configuration information of uplink SRS of the UE. Alternatively, the bearer context setup request message may carry the indication information on the identity of the UE, and may also carry timestamp information, which indicates a time(s) when the UE arrives at the gNB-CU-UP, and the gNB-CU-UP may reserve or allocate resources for the UE according to the time stamp(s) to avoid premature allocation of resources and a waste of resources.

Step 604: The gNB-CU-UP transmits a bearer establishment response message to the gNB-CU-CP.

The gNB-CU-UP transmits the bearer context setup response message to the gNB-CU-CP. The message comprises identifier of the UE on the E1 interface, and a list of PDU sessions successfully established. The list of the PDU sessions comprises identifiers of the PDU sessions, encryption results, and downlink transport layer addresses. The addresses are allocated by the gNB-CU-UP and used to receive downlink data transmitted by the core network. The message also comprises a list of DRBs successfully established. The list of the DRBs comprises DRB identifiers, information forwarded by DRB data, and uplink user plane information of the DRBs. The uplink user plane information comprises user plane transport layer addresses, cell group identifiers, and the like. The uplink user plane addresses are allocated by the gNB-CU-CP and are used to receive uplink data transmitted by the DU.

Step 605: The gNB-CU-CP transmits a UE context setup request message to the gNB-DU.

The gNB-CU-CP transmits the UE context setup request message to the gNB-DU. The message carries identifier of the UE on the F1 interface and configuration information of the data radio bearers DRBs to be established. The configuration information of the DRBs comprises identifiers of the DRBs, quality requirements (e.g., QoS) of the DRBs, information of the QoS flows mapped to the DRBs, and uplink transport layer addresses of the DRBs, such as IP addresses and TEIDs, which are used to receive uplink data. This message is allocated by the gNB-CU-UP. This message also carries information such as the RLC modes of the DRBs, PDCP sequence number length and the like.

The UE context setup request message may also comprise indication information on identity of the UE, which indicates whether the UE is a UE of the UAV type, or whether it has functions of an unmanned aerial vehicle, and comprises the flight route information of the UE, and the flight route information comprises a set of location information and timestamp information. Alternatively, the message comprises information of a time stamp(s), which indicates a time(s) when the UE arrives at the DU, and the DU may reserve or allocate resources for the UE according to the time stamp(s), so as to avoid premature allocation of resources and a waste of resources.

Step 606: The gNB-DU transmits a UE context setup response message to the gNB-CU-CP.

The gNB-DU transmits the UE context setup response message to the gNB-CU-CP. The message carries identifier of the UE on the F1, RRC information from the DU to the CU, C-RNTI of the UE, and a list of DRBs successfully established. The list of the DRBs comprises identifiers of the DRBs, logical channel identifiers (LCIDs), and downlink transport layer addresses of the F1 interface. The RRC information from DU to CU comprises cell group configuration information CellGroupConfig, measurement gap configuration information MeasGapConfig, and discontinuous line reception configuration and the like.

Step 608: The destination base station transmits a handover request acknowledge message to the core network AMF.

The destination base station transmits the handover request acknowledge message to the AMF. The message carries identifier of the UE on the NG interface and a list of PDU sessions accepted by the destination base station. The list of the PDU sessions comprises identifiers of the PDU sessions, downlink transport layer information, which is used to receive downlink data, and also comprises information forwarded by the data. The message also carries a transparent container from the destination to the source, and the transparent container comprises handover command message to be transmitted to the UE.

Step 609: The source base station transmits a handover command to the UE.

The source base station transmits the handover command transmitted by the destination base station to the UE.

Step 610: The UE synchronizes with the destination cell and transmits a handover complete message to the destination base station.

Step 611: The destination base station transmits a route switching notification message to the core network AMF.

The route switching notification message comprises location information of the UE, and the location information of the UE comprises the unique identifier of the cell where the UE is located, and identifier of the tracking area where the UE is located.

In step 612, the AMF transmits a UE context release message to the source base station, and the source base station releases the UE context.

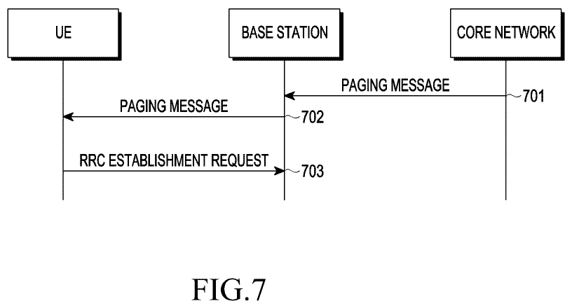

FIG. 7 depicts a schematic diagram of a process when the core network is to update a flight route of a UAV subscriber or entry prohibited area information. In this embodiment, the core network finds out that the UE is in idle mode, and the core network needs to update the information in time. Accordingly, the core network initiates a paging process to cause the UE to enter connected mode, and transmits the updated information to the UE and the base station, thereby improving the accuracy of controlling the unmanned aerial vehicle to avoid the UAV of flying into the entry prohibited area. The specific process is illustrated in FIG. 7.

Step 701, the AMF transmits a paging message to the base station.

The AMF checks the context information of the UE and finds out that the UE is in RRC inactive mode. When the UE is in the RRC inactive mode, the core network may find the UE in the Tracking Area (TA for short). If the core network has the flight route of the UE, the core network can determine which base station's coverage the UE is currently under, or which base stations' coverages the UE is under, and the core network may transmit the paging message to the corresponding base station. The AMF transmits the paging message to a base station(s) located within the range of the TA. The paging message may comprise the reason for paging, and the paging message may also comprise information of configured flight route. According to the information of configured flight route, the base station may determine whether the UE is in its service range, if the UE is in the range, the paging message is transmitted on the air interface, and the UE is not in the range, the paging message is not transmitted on the air interface, thereby reducing a waste of air interface resources.

The paging request message may also comprise information of updated flight route. The base station saves this information, and transmits the same to the UE in a subsequent RRC message.

Step 702: The base station transmits the paging message to the UE.

Step 703: The UE transmits an RRC establishment request message to the base station. Once the RRC connection is established, the UE may transmit a paging response message to the core network. This process is the same as the existing process and is omitted here. After that, the base station may transmit the information of the updated flight route to the UE through an RRC message.

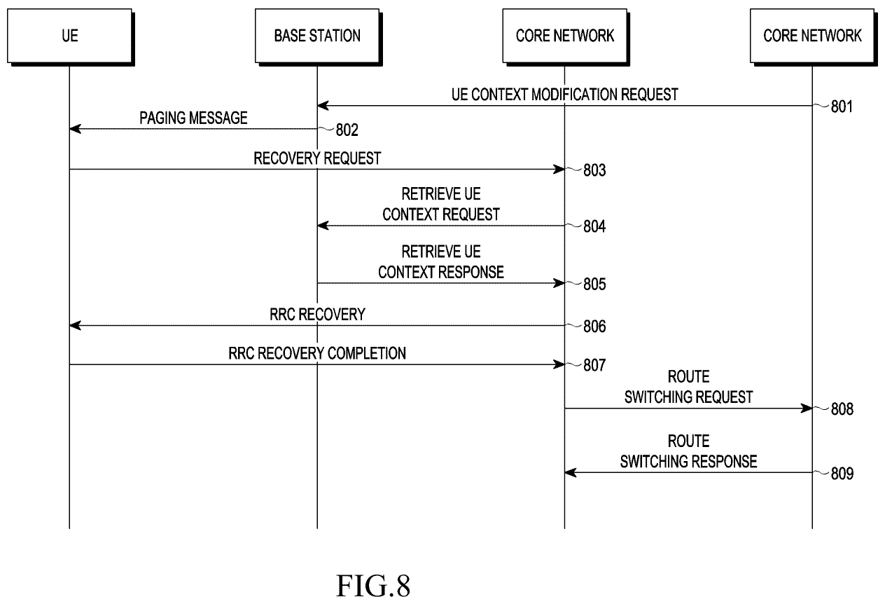

FIG. 8 depicts a schematic diagram of a process of how to obtain information on a flight route or entry prohibited area information when a UE is in the RRC inactive mode. The core network needs to update this information and transmit the updated information to the base station. The specific process is illustrated in FIG. 8.

Step 801: The AMF transmits a UE context modification message to the source base station, which comprises information about a flight route or entry prohibited area.

Step 802: The source base station transmits a RAN paging message to the base station under the coverage of the RAN.

Step 803: The UE moves to a new cell. In the new cell, the UE receives the RAN paging message, and the UE transmits a recovery request message to the new base station. The message comprises identifier of the UE, such as I-RNTI, identifier of the previous serving base station and identifier of the cell.

Step 804: The new base station transmits aRetrieve UE context request message to the old base station. The CU-CP2 receives the RRC recovery request message, and finds the original serving base station (or called the old base station) of the UE according to the information carried in the message. The new base station transmits the Retrieve UE context request message to the old base station, which carries identifier of the old base station, cell identifier and subscriber identifier of the UE in the old cell C-RNTI. Upon receipt of the message in this step, the old base station determines to transmit the context information of the UE to the new base station.

Step 805: The old base station transmits a Retrieve UE context response message to the new base station.

The message comprises the context information of the UE, and according to the method of this application, comprises indication information on identity of the UE. Specifically, the indication information indicates whether the UE is a UE of the UAV type, or whether it has functions of an unmanned aerial vehicle, and comprises flight route information and/or entry prohibited area information and/or alternative flight route information of the UE.

Upon receipt of this message, the new base station saves the indication information, the flight route information or the entry prohibited area information of the UE, or the information on the alternative route in the context of the UE for mobility management. When selecting a serving cell, the new base station refers to this information, and does not configure any cell in the entry prohibited area as a serving cell of the UE, or when performing the handover, the new base station refers to the information of the entry prohibited area, and does not hand over the UE to the entry prohibited area.

Step 806: The new base station transmits a RRC recovery request message to the UE.

The message comprises configuration information of a bearer(s) of the UE, the configuration information of the SRB, and the like. According to the method of the present application, the message comprises the flight route information and/or entry prohibited area information and/or alternative flight route information of the UE.

Upon receipt of this message, the flight route information, the alternative flight route information or the entry prohibited area information of the UE are saved in the context of the UE for mobility management. When cell reselection is performed, the entry prohibited area information is referred to, so as to avoid of accessing to a cell in the entry prohibited area. The flight route information or the alternative flight route information saved by the UE may be reported to the new base station when the UE hands over to the new base station. How to report this has been described in Embodiment 1 and is omitted here.

Alternatively, after the recovery process is completed, the base station comprises the flight route information and/or entry prohibited area information, and/or the information on the alternative route in an RRC reconfiguration request message and transmits the RRC reconfiguration request message to the UE, so as to notify the UE of the flight route information and/or entry prohibited area information through this message.

Step 807: The UE transmits a RRC recovery complete message to the new base station.

Step 808: The new base station transmits a route switching request message to the core network AMF.

Step 809: The AMF transmits a route switching response message to the new base station.

FIG. 10 discloses a flowchart of a schematic method performed by a first node according to yet another embodiment of the present disclosure. In various embodiments, the first node may be a source base station or a destination base station or a base station centralized unit control plane CU-CP node or a base station distributed unit DU or a base station centralized unit user plane CU-UP node.

In various embodiments, the second node may be a source base station, a destination base station, a base station centralized unit control plane CU-CP node, or a core network node. In one embodiment, the core network node may be an AMF.

In step 1001, a first node receives a first message from a second node, the first message including flight route information.

In a further embodiment, the flight route information comprises at least one timestamp and location information corresponding to the timestamp(s).

In a further embodiment, the first message further comprises a flight altitude and/or flight speed of the UE.

In a further embodiment, the method further comprises: receiving from the second node information on an entry prohibited area, the information on the entry prohibited area indicating a range in which the UE is not allowed to enter; and performing UE mobility management based on the information on the entry prohibited area.

In various embodiments, the information on the entry prohibited area comprises at least one of: information on an identifier of the cell, information on a location of a global positioning system GPS of the UE, and information on a tracking area TA.

In various embodiments, the information on the entry prohibited area is received through the first message or a second message.

In a further embodiment, the method further comprises: receiving information on an alternative route from the second node, the information on the alternative route indicating information on an alternative route for the case when the UE is temporarily prohibited from entering an area; and performing UE mobility management based on the information on the alternative route.

In various embodiments, the information on the alternative route is received through the first message or the second message.

In various embodiments, the information on the alternative route is transmitted to the UE through an RRC message.

In a further embodiment, the method further comprises: receiving, from the second node, uplink sounding reference signal SRS configuration information of the UE, wherein the uplink SRS configuration information is saved in a UE context for uplink interference detection.

In a further embodiment, the uplink SRS configuration information is received through the first message.

In various embodiments, the first message is at least one of: a UE context setup request message, a handover request message, a UE context modification request, a route switching response, and an RETRIEVE UE Context response message.

In various embodiments, the first message is a configuration request message or a bearer context setup request message.

In various embodiments, the second message is at least one of: a UE context setup request message, a handover request message, a UE context modification request, a route switching response, and an RETRIEVE UE Context response message.

In various embodiments, the second message is a configuration request message and a bearer context setup request message.

In step 1002, the first node allocates resources to user equipment UE based on the first message.

In a further embodiment, the method further comprises: determining whether to transmit a paging message to the UE based on the flight route information; wherein the first node is a base station, the second node is a core network node, and the first message is a paging message.

FIG. 11 is a schematic diagram of a first node according to an exemplary embodiment of the present disclosure.

Referring to FIG. 11, the first node according to an exemplary embodiment of the present disclosure includes a controller (1110), and a transceiver (1120).

According to another aspect of the present disclosure, there is provided a first node in a wireless communication system, comprising: a transceiver configured to transmit and receive a signal; and a controller coupled to the transceiver and configured to perform operations in the method as described above.

In various embodiments, the first node is a source base station or a destination base station or a base station distributed unit DU or a base station centralized unit user plane CU-UP node or a base station centralized unit control plane CU-CP node.

According to another aspect of the present disclosure, there is provided a method performed by a user equipment UE in a wireless communication system, the method comprising: receiving information on an entry prohibited area from a base station, the information on the entry prohibited area indicating a range in which the UE is not allowed to enter; and performing cell selection based on the information on the entry prohibited area.

In a further embodiment, the method further comprises: transmitting a first message to the base station, wherein the first message comprises flight route information, and the first message is used by the base station to allocate a resource for the user equipment UE.

In one embodiment, the flight route information comprises at least one timestamp and location information corresponding to the timestamp(s).

In a further embodiment, the first message further comprises a flight altitude and/or flight speed of the UE.

In a further embodiment, the method further comprises: receiving the information on the alternative route transmitted through a RRC message from the base station.

According to another aspect of the present disclosure, there is provided a user equipment UE in a wireless communication system, comprising: a transceiver configured to transmit and receive a signal; and a controller coupled to the transceiver and configured to perform operations in the method as described above.

So far, the method and device for supporting movement of an unmanned aerial vehicle according to the embodiments of the present application are achieved. The method and device of the present application can effectively control the unmanned aerial vehicle, avoid a unmanned aerial vehicle from flying into the entry prohibited area, increase the handover success rate of the unmanned aerial vehicle, reduce the waste of network resources, and improve the handover performance.

Those skilled in the art will understand that the above-described illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily appreciated that the various aspects of the disclosed invention, as generally described herein and illustrated in the accompanying drawings, may be arranged, substituted, combined, separated, and designed in various different configurations, all of which are herein was envisaged.

Those of skill in the art will understand that the various illustrative logical blocks, modules, circuits, and steps described herein can be implemented as hardware, software, or combinations of both. To clearly illustrate this interchangeability of hardware and software, various illustrative components, blocks, modules, circuits, and steps have been described above generally in terms of their function sets. Whether such a feature set is implemented as hardware or software depends on the specific application and design constraints imposed on the overall system. Those skilled in the art may implement the described function sets in varying ways for each particular application, but such design decisions should not be interpreted as causing a departure from the scope of this application.

The various illustrative logical blocks, modules, and circuits described in this application may be implemented or performed in general-purpose processors, digital signal processors (DSPs), application specific integrated circuits (ASICs), field programmable gate arrays (FPGAs) or other programmable logic devices, discrete gates or transistor logics, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, such as a combination of a DSP and a microprocessor, multiple microprocessors, one or more microprocessors cooperating with a DSP core, or any other such configuration.

The steps of a method or algorithm described herein may be embodied directly in hardware, in a software module executed by a processor, or in a combination of the two. A software module may reside in RAM memory, flash memory, ROM memory, EPROM memory, EEPROM memory, registers, hard disk, removable disk, or any other form of storage medium known in the art. An exemplary storage medium is coupled to the processor such the processor can read information from, and write information to, the storage medium. In the alternative, the storage medium may be integrated into the processor. The processor and storage medium may reside in the ASIC. The ASIC may reside in the user terminal. In the alternative, the processor and storage medium may reside in the user terminal as discrete components.

In one or more exemplary designs, the functions may be implemented in hardware, software, firmware, or any combination thereof. If implemented in software, the functions may be stored on or transmitted over as one or more instructions or code in a computer-readable medium. Computer-readable media comprises both computer storage media and communication media including any medium that facilitates transfer of a computer program from one place to another. A storage medium can be any available medium that can be accessed by a general purpose or special purpose computer.

The above description is only exemplary embodiments of the present invention and is not intended to limit the scope of the present invention, which is defined by the appended claims.

1.-15. (canceled)

16. A method performed by a first base station in a wireless communication system, the method comprising:
receiving, from an access and mobility management function (AMF) entity, a first message including aerial user equipment (UE) information about a UE;
transmitting, to the UE, a request to report flight path information; and
receiving, from the UE, a report for the flight path information.

17. The method of claim 16, wherein the flight path information includes timestamp information and location information.

18. The method of claim 16, further comprising:
receiving, from the UE, a radio resource control (RRC) message including indication indicating that the flight path information is available,
wherein the request to report flight path information is transmitted based on the indication indicating that the flight path information is available.

19. The method of claim 16, further comprising:
transmitting, to a second base station, a second message including at least one of the flight path information and the aerial UE information.

20. The method of claim 16, further comprising:
transmitting, to a second node, third information on an alternative route if the UE is temporarily prohibited from entering an area, through a radio resource control (RRC) message; and
performing UE mobility management based on the third information,
wherein the third information is received through the first message or a second message, and
wherein the first message further includes at least one of a flight altitude, or flight speed of the UE.

21. The method of claim 16, further comprising:
receiving, from a core network entity, uplink sounding reference signal (SRS) configuration information of the UE,
wherein the uplink SRS configuration information is saved in a UE context for uplink interference detection, and
wherein the uplink SRS configuration information is received through the first message.

22. The method of claim 19, wherein the second message includes at least one of a UE context setup request message, a handover request message, a UE context modification request, a route switching response, or a RETRIEVE UE Context response message.

23. The method of claim 20,
wherein the first base station includes a source base station, and
wherein the second node is a source base station, a destination base station, a base station centralized unit-control plane (CU-CP) node, or a core network node.

24. The method of claim 18, further comprising,
determining to transmit a paging message to the UE based on the flight path information; and
transmitting, to the UE, the paging message.

25. A first base station in a wireless communication system, the first base station comprising:
a transceiver; and
at least one processor configured to:
receive, from an access and mobility management function (AMF) entity, a first message including aerial user equipment (UE) information about a UE,
transmit, to the UE, a request to report flight path information, and
receive, from the UE, a report for the flight path information.

26. The first base station of claim 25, wherein the flight path information includes timestamp information and location information.

27. The first base station of claim 25,
wherein the at least one processor is further configured to:
receive, from the UE, a radio resource control (RRC) message including indication indicating that the flight path information is available, and
wherein the request to report flight path information is transmitted based on the indication indicating that the flight path information is available.

28. The first base station of claim 25, wherein the at least one processor is further configured to:
transmit, to a second base station, a second message including at least one of the flight path information and the aerial UE information.

29. The first base station of claims 25,
wherein the at least one processor is further configured to:
transmit, to a second node, third information on an alternative route if the UE is temporarily prohibited from entering an area, through a radio resource control (RRC) message; and
perform UE mobility management based on the third information,
wherein the third information is received through the first message or a second message, and
wherein the first message further includes at least one of a flight altitude, or flight speed of the UE.

30. A method performed by a user equipment (UE) in a wireless communication system, the method comprising:
receiving, from a base station, a request to report flight path information; and
transmitting, to the base station, a report for the flight path information,
wherein aerial user equipment (UE) information about a UE is transmitted from an access and mobility management function (AMF) entity.

31. The method of claim 30, wherein the flight path information includes timestamp information and location information.

32. The method of claim 30, further comprising:
transmitting, to the base station, a radio resource control (RRC) message including indication indicating that the flight path information is available,
wherein the request to report flight path information is transmitted based on the indication indicating that the flight path information is available.

33. A user equipment (UE) in a wireless communication system, the UE comprising:
a transceiver; and
at least one processor configured to:
receive, from a base station, a request to report flight path information, and
transmit, to the base station, a report for the flight path information,
wherein aerial user equipment (UE) information about a UE is transmitted from an access and mobility management function (AMF) entity.

34. The UE of claim 33, wherein the flight path information includes timestamp information and location information.

35. The UE of claim 33,
wherein the at least one processor is further configured to:
transmit, to the base station, a radio resource control (RRC) message including indication indicating that the flight path information is available, and
wherein the request to report flight path information is transmitted based on the indication indicating that the flight path information is available.
